(19) United States
(12) Patent Application Publication
(10) Pub. No.: US 2004/0053055 A1
(43) Pub. Date: Mar. 18, 2004

(54) Rubber toughened epoxy resins for resin infusion processing, methods of using the resins and articles made therefrom

(76) Inventors: John W. Robinson, Fernandina Beach, FL (US); Craig L. Cartwright, Jacksonville, FL (US)

Correspondence Address: William C. Tritt, Renner, Otto, Boisselle & Sklar, LLP, Nineteenth Floor, 1621 Euclid Avenue, Cleveland, OH, 44115-2191, US

(21) Appl. No.: 10/612,850

(22) Filed: Jul. 3, 2003

Related U.S. Application Data
(60) Provisional application No. 60/394,456, filed on Jul. 8, 2002.
(60) Provisional application No. 60/393,671, filed on Jul. 3, 2002.

(51) Int. Cl. B32B 27/38

(52) U.S. Cl. 428/413; 428/430

(57) ABSTRACT

The present invention relates to a curable composition comprising a) at least one epoxy resin, b) at least one reactive liquid polymer, and c) at least one reaction product of an epoxy resin and a reactive liquid polymer. These curable compositions provide improved toughness and higher temperature performance when cured. The curable compositions are easy to handle in terms of their viscosity. The present invention also relates to methods of making articles, such as laminates and the articles made with the curable composition.

### CROSS REFERENCE TO RELATED PROVISIONAL APPLICATIONS

This application claims priority from provisional application U.S. serial No. 60/393,671, filed Jul. 3, 2002 and U.S. serial No. 60/394,456, filed Jul. 8, 2002. These applications are hereby incorporated by reference in their entirety.

### TECHNICAL FIELD OF THE INVENTION

This invention relates to rubber toughened epoxy resins, articles made therefrom and methods of preparing the articles. More specifically, the invention relates to the combination of an epoxy resin, a liquid reactive polymer and a reaction product of an epoxy resin and a liquid reactive polymer. This combination is cured and with reinforcing material forms high performance laminates and/or articles.

### BACKGROUND OF THE INVENTION

Fiber reinforced composite parts are fabricated utilizing a variety of conventional techniques including resin infusion, resin transfer molding (RTM), prepreg/autoclave procedures, and compression molding operations. Resin infusion consists of infusing a preform with liquid resin under vacuum using a one sided tool. Resin transfer molding differs from resin infusion by infusing the preform with liquid resin under pressure with or without vacuum using a matched, two sided tool capable of withstanding the pressure. Fiber reinforced plastic structures have been commercially produced for some years. Examples of manufacturing techniques can be found in U.S. Pat. No. 5,052,906 Entitled “Plastic Transfer Molding Apparatus For The Production of Fiber Reinforced Plastic Structures”, U.S. Pat. No. 5,601,852 Entitled “Unitary Vacuum Bag For Forming Fiber Reinforced Composite Articles And Process For Making Same”, U.S. Pat. No. 4,132,755 Entitled “Process For Manufacturing Resin-Impregnated, Reinforced Articles Without The Presence Of Resin Fumes”, U.S. Pat. No. 5,129,813 Entitled “Embossed Vacuum Bag, Methods For Producing And Using Said Bag”, U.S. Pat. No. 4,902,215 Entitled “Plastic Transfer Molding Techniques For The Production Of Fiber Reinforced Plastic Structures”, U.S. Pat. No. 4,942,013 Entitled “Vacuum Resin Impregnation Process”, U.S. Pat. No. 5,439,635 Entitled “Unitary vacuum Bag For Forming Fiber Reinforced Composite Articles And Process For Making Same”, U.S. Pat. No. 5,281,388 Entitled “Resin Impregnation Process For Producing A Resin-Fiber Composite”, U.S. Pat. No. 5,316,462 Entitled “Unitary Vacuum Bag For Forming Fiber Reinforced Composite Articles, and U.S. Pat. No. 2,913,036 Entitled Process And Apparatus For Molding Large plastic Structures”.

The process for producing these structures requires the incorporation of a resin or other flowable plastic material into a reinforcing fiber. Reinforcing fiber generally takes the form of one or more layers of a woven or felted fiber reinforcement, typically comprised of carbon, graphite, or fiberglass. The resin infusion or impregnation process is usually done by either a wet or dry fiber lay-up technique. In the wet fiber lay-up process, the resin “wetted” fiber reinforcement consists of a prepreg which already contains a resin and is laid up on a mold and cured.

In the dry lay-up process, the fiber reinforcement is laid up dry on a mold or form which serves as a mold. The form may be incorporated as part and parcel of the finish product. Thereafter, the fiber is sprayed, brushed, impregnated, infused, or otherwise coated or “wetted” with the resin. The resin is then cured to form the fiber reinforced plastic structure.

During the curing stage of either process, the structure can be placed in a vacuum to assist the curing process. To this end, vacuum bag techniques have been used to provide such vacuum assistance. In a vacuum technique, a flexible impervious sheet, liner, or bag is used to cover a single mold which contains the dry or wet (resin impregnated) fiber lay-up. In the wet fiber process, the edges of the flexible sheet are clamped against the mold to form an envelope and seal the resin impregnated fiber lay-up to the mold and out of the atmosphere. A vacuum is then applied to consolidate the preform during the cure of the resin. In the dry fiber lay-up, catalyzed liquid plastic or resin is generally introduced into the envelope or bag interior to wet the dry fiber, usually using a vacuum to help push the resin into the bag and wet out the dry fiber. Vacuum is applied to the bag interior via a vacuum line to collapse flexible sheet against the fiber and surface of the mold, while the plastic wetted fiber is processed, compacted and cured to form the fiber reinforced structure. The vacuum bag used in this process is critical because it provides not only a vacuum seal but also a distribution mechanism for moving the liquid resin over the preform. These flexible bags are difficult to work with and although some are considered to be reusable, are typically inadequate for large volume manufacturing production. Also, flexible bags do not perform adequately when used by themselves for processing complex three dimensional shapes. It has been found that flexible bags do not conform entirely to the reinforced structure around corners and other high radius curves. “Bridging” is a term used to describe this condition. When the flexible bag bridges across corners, a gap or void is created between the bag and the reinforced structure, thereby preventing a continuous, uniform distribution of resin.

What is needed then is a technique for a resin infusion process for complex shapes which can be used repeatedly, applied quickly, is reliable in holding perfect vacuum and provides uniform resin distribution. Efforts in this area have lead to continuing developments to improve their versatility, practicality and efficiency.

### SUMMARY OF THE INVENTION

The present invention relates to a curable composition comprising a) at least one epoxy resin, b) at least one reactive liquid polymer, and c) at least one reaction product of an epoxy resin and a reactive liquid polymer. These curable compositions provide improved toughness and higher temperature performance when cured. The curable compositions are easy to handle in terms of their viscosity. The present invention also relates to methods of making articles, such as laminates and the articles made with the curable composition.

### BRIEF DESCRIPTION OF THE DRAWINGS

FIG. 1A is an isometric view of a rigid mold for use in the resin infusion process in accordance with the present invention.

FIG. 1B is a side view of FIG. 1A taken along line 1A-1A.

FIG. 2A is an isometric view of the mold in FIG. 1A, having reinforced material disposed thereon.

FIG. 2B is a side view of FIG. 2A, taken along line 2A-2A.

FIG. 3A is an isometric view of the assembly in FIG. 2A, having semi-rigid tool segments provided thereon in accordance with the present invention.

FIG. 3B is a side view of FIG. 3A, taken along line 3A-3A.

FIG. 3C is an enlarged top view of the area of the assembly in FIG. 3A around the gap tool segment gap.

FIG. 4A is an isometric view of the assembly shown in FIG. 3A, further having a sealing bag provided thereon.

FIG. 4B is a side view of FIG. 4A, shown along line 4A-4A.

FIG. 4C is an enlarged top view of the area of the assembly in FIG. 4A around the gap tool segment gap.

FIG. 5 is an enlarged isometric view of a portion of a semi-rigid tool and reinforced material in accordance with the present invention.

FIG. 6 is an enlarged, plan view of a portion of an alternative embodiment of a semi-rigid tool in accordance with the present invention.

FIG. 7 is an enlarged isometric view of a portion of an alternative embodiment semi-rigid tool in accordance with the present invention.

### DETAILED DESCRIPTION OF THE PREFERRED EMBODIMENTS

As described above the present invention relates to a curable composition, methods of using the composition and articles made therefrom. These curable compositions have good viscosity characteristics for resin infusion. The gel time is low enough to provide adequate fill, for even intricate parts. The curable compositions can be used at temperatures above about 100° F., or even over about 110° F. Typical operating temperatures are around about 120° F. At the above mentioned operating temperatures, the curable compositions have viscosities below about 450, or below about 400, or below about 350. In one embodiment, the cured compositions have a glass transition temperature of greater than about 85, or greater than about 90, or greater than about 100° C.

In one embodiment, the glass transition temperatures are post baked glass transition temperatures. Post baking occurs after the curing stage. To obtain the useful glass transition temperatures from the resin chemistry. The part would be post baked to a temperature close to the desired glass transition temperature for a duration based on part thickness and oven temperature. Post baking can be done free standing or on the mold to complete the cure and obtain the optimum glass transition temperature. In this embodiment, the resin is post baked for one to about eight, or for two to about six hours at about 55 to about 110, or from about 65 to about 100, or from about 75 to about 95 degrees Celsius. A useful glass transition temperature may be obtained by An example of a this free standing glass transition temperature is post baking a resin at 85 degrees Celsius for two hours in an oven.

The curable compositions are cured with a reinforcing material to form laminates, these laminates are discussed below in more detail. The laminates have good toughness. In one embodiment, the laminate have a G1c toughness of equal to or greater than about 6, or equal to or greater than about 7, or equal to or greater than about 8.

Epoxy Resins:

As described above the curable compositions contain at least one epoxy resins. The epoxy resins are present in the curable compositions in a major amount. In one embodiment, the curable composition is present in an amount from about 50 to about 90, or from about 55 to about 85, or from about 60 to about 70 parts by weight. Here and elsewhere in the specification and claims the range and ratio limits may be combined.

In general, an epoxy resin is a compound containing more than one a (alpha) or 1,2-epoxy group and which is capable of being converted to a useful thermoset or cured state by a curing agent as discussed hereinbelow. The a-epoxy group may be situated internally, terminally, or on cyclic structures.

Epoxy resins which are suitable for use in the present invention include many commercially available epoxy resins including diepoxy resins which are well-known to the art and to the literature. Desirable epoxy resins include polyhydric phenol polyether alcohols; glycidyl ethers of novolac resins such as epoxylated phenol-formaldehyde novolac resin; glycidyl ethers Of mononuclear di- and trihydric phenols; glycidyl ethers of bisphenols such as diglycidyl ether of tetrabromobisphenol A; glycidyl ethers of polynuclear phenols; epoxy resin from diphenolic acid; glycidyl ethers of aliphatic polyols such as chlorine-containing aliphatic diepoxy and polyepichlorohydrin; glycidyl esters such as aliphatic diacid glycidyl esters and epoxidized phenolphthalein; glycidyl epoxies containing nitrogen such as glycidyl amides and amide-containing epoxies; glycidyl derivatives of cyanuric acid; glycidyl resins from melamines; glycidyl amines such as triglycidyl ether amine of p-aminophenol and bis(2,3-epoxypropyl)methylpropylammonium p-toluenesulfonate; and glycidyl triazines; thioglycidyl resins such as epoxidized bisulfide; silicon-glycidyl resins such as 1,4-bis[(2,3-epoxypropoxy)dimethylsilyl]; fluorine glycidyl resins; epoxy resins which are synthesized from monoepoxies other than epihalohydrins including epoxy resins from unsaturated monoepoxies such as polyallyl glycidyl ether and glycidyl sorbate dimer; epoxy resins from monoepoxy alcohols; epoxy resins from monoepoxies by ester interchange; epoxy resins from glycidaldehyde; polyglycidyl compounds containing unsaturation such as allyl-substituted diglycidyl ether of bisphenol A; epoxy resins which are synthesized from olefins and chloroacetyls such as butadiene dioxide, vinylcyclohexene dioxide, epoxidized polybutadiene, and bis(2,3-epoxycyclopentyl)ether; and epoxy-resin adducts of the above. A more comprehensive list of epoxy resins can be found in Handbook of Epoxy Resins, by Henry Lee and Kris Neville, McGraw-Hill, Inc., 1967, which is hereby incorporated by reference.

There is a host of commercially available epoxy resins which can be used in this invention. In particular, epoxides which are readily available include octadecylene oxide, epichlorohydrin, styrene oxide, vinylcyclohexene oxide, glycidyl methacrylate, diglycidyl ether of Bisphenol A (for example, those available under the trade designations “EPON 828,” “EPON 1004,” and “EPON 1001 F” from Shell Chemical Co., Houston, Tex., and “DER-332” and “DER-334”, from Dow Chemical Co., Midland, Mich.), diglycidyl ether of Bisphenol F (for example, those under the trade designations “ARALDITE GY281” from Ciba-Geigy Corp., Hawthorne, N.Y., and “EPON 862” from Shell Chemical Co.), vinylcyclohexene dioxide (for example, having the trade designation “ERL 4206” from Union Carbide Corp., Danbury, Conn.), 3,4-epoxycyclohexyl-methyl-3,4-epoxycyclohexene carboxylate (for example, having the trade designation “ERL-4221” from Union Carbide Corp.), 2-(3,4-epoxycyclohexyl-5,5-spiro-3,4-epoxy) cyclohexane-metadioxane (for example, having the trade designation “ERL-4234” from Union Carbide Corp.), bis(3,4-epoxycyclohexyl) adipate (for example, having the trade designation “ERL-4299” from Union Carbide Corp.), dipentene dioxide (for example, having the trade designation “ERL-4269” from Union Carbide Corp.), epoxidized polybutadiene (for example, having the trade designation “OXIRON 2001” from FMC Corp.), epoxy silanes, for example, beta-3,4-epoxycyclohexylethyltrimethoxysilane and gamma-glycidoxypropyltrimethoxysilane, commercially available from Union Carbide, flame retardant epoxy resins (for example, having the trade designation “DER-542,” a brominated bisphenol type epoxy resin available from Dow Chemical Co.), 1,4-butanediol diglycidyl ether (for example, having the trade designation “ARALDITE RD-2” from Ciba-Geigy Corp.), hydrogenated bisphenol A-epichlorohydrin based epoxy resins (for example having the trade designation “EPONEX 1510” from Shell Chemical Co.), and polyglycidyl ethers of phenol-formaldehyde novolaks (for example, having the trade designation “DEN-431” and “DEN-438” from Dow Chemical Co.).

Reactive Liquid Polymer (RLP)

As discussed above the curable compositions include a reactive liquid polymer. These polymers are generally present in an amount from about 5 to about 25, or from about 7 to about 20, or from about 9 to about 15 parts by weight.

Suitable RLPs for reaction into the backbone of the unsaturated polyester resin include the following: dicarboxyl-terminated polymers, dihydroxy-terminated polymers, diepoxy-terminated polymers, reaction product statistical monofunctional carboxyl-terminated polymers, reaction product statistical monofunctional hydroxy-terminated polymers, reaction product statistical monofunctional epoxy-terminated polymers, blended product statistical monofunctional carboxyl-terminated polymers, blended product statistical monofunctional hydroxy-terminated polymers and blended product statistical monofunctional epoxy-terminated polymers. Each of these polymer types is described in greater detail below.

Liquid dicarboxyl-terminated polymers useful for reaction into the backbone of the precursor unsaturated polyester resin may be prepared by free-radical polymerization using carboxyl-containing initiators and/or modifiers as disclosed in U.S. Pat. No. 3,285,949 and German Patent No. 1,150,205, and by solution polymerization using lithium metal or organometallic compounds and post-treating the polymers to form carboxyl groups, as disclosed in U.S. Pat. Nos. 3,135,716 and 3,431,235. The polymers can also be prepared by reacting liquid polymers having other than terminal carboxyl groups with compounds so as to yield carboxyl groups. For example, liquid carboxyl-terminated polymers can be prepared from liquid hydroxyl-terminated polymers by reaction with dicarboxylic acids or their anhydrides. Liquid halogen-terminated polymers can be reacted with unsaturated anhydrides in the presence of Lewis acids to yield carboxyl groups. Thus, it is seen that the method of preparing the liquid statistical dicarboxyl-terminated polymer is not critical to the invention. The essential features of the polymer are that it have statistical difunctional terminal carboxyl groups and a polymeric backbone of carbon-carbon linkages.

The dicarboxyl-terminated liquid polymers suitably have Brookfield viscosities of from about 500 cps to about 2,500,000 cps at 25° C., or from about 5000 cps to about 1,200,000 cps, and have polymeric backbones comprising carbon-carbon linkages. The dicarboxyl-terminated liquid polymers typically have carboxyl equivalent weights (gram molecular weight per carboxyl group) from about 300 to about 5,000, or from about 600 to about 3,000. The carboxyl functional groups are located at least at the ends of a polymer molecule, but there may also be additional groups(s) located pendant to a polymer backbone. The average number of total carboxyl groups typically may be from about 0.5 to about 4 groups per molecule, or from about 0.7 to about 2.5 groups per molecule.

The backbone carbon-carbon linkages of the dicarboxyl-terminated liquid polymers typically contain polymerized units of at least one vinylidene monomer. Examples of suitable acrylates include ethyl acrylate, butyl acrylate, hexyl acrylate, 2-ethylhexyl acrylate, dodecyl acrylate, octadecyl acrylate, methoxyethyl acrylate, butoxyethyl acrylate, hexylthioethyl acrylate, β-cyanoethyl acrylate, cyanooctyl acrylate, methyl methacrylate, ethyl methacrylate, octyl methacrylate, and the like. Often two or more types of these polymerized monomeric units are contained in the polymeric backbone.

The vinylidene monomers described above may be polymerized readily with from 0 percent up to about 50 percent by weight, and more preferably from 0 percent up to about 35 percent by weight, of at least one comonomer selected from the group consisting of (f) vinyl aromatics such as styrene, a-methyl styrene, chlorostyrene, vinyl toluene, and the like; (g) vinyl nitriles such as acrylonitrile, methacrylonitrile, and the like; (h) divinyls and diacrylates such as divinyl benzene, divinyl ether, diethylene glycol diacrylate, and the like; (i) amides of α,β-olefinically unsaturated carboxylic acids containing 2 to 8 carbon atoms such as acrylamide, and the like; and (j) allyl alcohol and the like.

Examples of liquid dicarboxyl-terminated polymers include carboxyl-terminated polyethylene, polyisobutylene, polybutadiene, polyisoprene, poly(ethylacrylate), as well as carboxyl-terminated copolymers of butadiene and acrylonitrile, butadiene and acrylates, and butadiene and styrene. Carboxyl-terminated copolymers of butadiene with acrylonitrile or styrene were found to be especially useful. These polymers may contain from about 50 percent to about 100 percent by weight of butadiene, from about 0 percent to about 40 percent by weight of acrylonitrile or styrene and from about 1 percent to about 15 percent by weight of carboxyl groups, based upon the total weight of the polymer.

Another example of a liquid dicarboxyl-terminated polymer useful for reaction into the backbone of the precursor unsaturated polyester resin is difunctional carboxyl-terminated butadiene-acrylonitrile-acrylic acid type terpolymer.

A commercially available carboxyl-terminated butadiene-acrylonitrile-acrylic acid terpolymer may be approximately containing from about 17 percent to about 20 percent acrylonitrile and has a molecular weight of from about 2,000 to about 15,000. The terpolymer has a functionality of about 2.3. This polymer is commercially available from The B. F. Goodrich Company as HYCAR™. CTBNX reactive liquid polymer.

Useful polymers are those known as “HYCAR” polymers CTB, CTBN, and CTBNX commercially available from The B. F. Goodrich Company, U.S.A.

The CTBN polymer is a carboxyl-terminated butadiene-acrylonitrile type random copolymer containing 10 percent acrylonitrile or 17 percent acrylonitrile, or 26 percent acrylonitrile.

The CTBNX polymer is a carboxyl-terminated butadiene-acrylonitrile-acrylic acid terpolymer wherein the terpolymer contains from about 17 percent to about 20 percent acrylonitrile and generally has a molecular weight of from about 2,000 to about 15,000. The terpolymer has a functionality of about 2.3.

Another carboxyl-terminated polymers are polybutadiene homopolymer α,ω-(4-cyano-4-methyl butyric acid) which is commercially available as HYCAR 2000×162 from The B. F. Goodrich Company and copolymers of 1,3-butadiene/acrylonitrile with α,ω-(4-cyano-4-methyl butyric acid), which is commercially available from The B. F. Goodrich Company, U.S.A. as HYCAR 1300×8 reactive liquid polymer and contains 16% bound acrylonitrile. The best results were obtained using such a copolymer containing 26% bound acrylonitrile, commercially available as HYCAR 1300×13 reactive liquid polymer from The B. F. Goodrich Company, U.S.A.

Another example of a suitable RLP for use in the present invention is epoxy-terminated butadiene-acrylonitrile rubber (ETBN). One suitable epoxy-terminated butadiene-acrylonitrile rubber is sold by The B. F. Goodrich Company, U.S.A. under the label ETBN ×40 (also known as HYCAR 1300×40) and contains 17 percent bound acrylonitrile. This product is sold commercially as a 50 percent solution in styrene.

Liquid dihydroxyl-terminated polymers useful for reaction into the backbone of the precursor unsaturated polyester resin can also be prepared in several different ways. For instance, carboxyl-terminated liquid polymers can be reacted with ethylene oxide in the presence of a tertiary amine catalyst, as described in the Siebert U.S. Pat. No. 3,712,916, or with a diol in presence of an acid catalyst, as described in the Siebert U.S. Pat. No. 3,699,153. These reactive liquid polymers have a Brookfield viscosity at 25° C. in the range of 500 to about 100,000,000, and preferably 5,000 to 2,000,000.

Still another type of dihydroxyl terminated liquid polymers are those containing sulfur linkages near terminal portions thereof and can be prepared by photopolymerizing at least one alkyl acrylate in the presence of a hydroxyl-containing disulfide. Examples of suitable hydroxyl-containing disulfides include 2-hydroxyethyl disulfide, 3-hydroxypropyl disulfide, and the like. Excellent results were obtained using 2-hydroxyethyl disulfide. The disulfide acts both as a polymerization initiator and as a polymerization modifier. The amount of hydroxyl-containing disulfide will vary according to the desired polymeric molecular weight but typically is from about 1 to 20 weight percent, and or from 1 to 10 weight percent, based upon total monomeric weight.

The photopolymerization may be conducted by any method known to the art, including bulk, solution, suspension and emulsion methods. Solvents for the monomer and/or polymer can be used during polymerization, including benzene, aliphatic hydrocarbons such as hexane and heptane, and alcohols such as methanol, ethanol, t-butanol, and the like. Well known suspension techniques comprise suspending the monomeric material, preferably already mixed with the hydroxyl-containing disulfide, in the form of small particles in a nonsolvent liquid such as water, together with a suspending agent to aid in maintaining the particles separate from one another during polymerization. Suitable suspending agents include starch, carboxymethylcellulose, and the like. Emulsion polymerization is similar, except that emulsifiers are used to produce much smaller particles, and the end product is a stable aqueous emulsion of the polymer. Suitable emulsifiers include sodium or potassium fatty acid soaps, sodium alkylaryl sulfonates, and the like.

Ultraviolet (UV) radiation suitable for use in this method have a wavelength of from about 1850 Angstroms to about 6000 Angstroms, and more preferably from about 2,400 Angstroms to about 4,000 Angstroms. Common sources of UV radiation include mercury lamps and arcs, carbon arcs and hydrogen discharge tubes. In some cases, a sensitizer may be useful in catalytic amounts to accelerate the photopolymerization, including ketones such as acetone, benzophenone, and the like.

Dihydroxyl-terminated liquid polymers containing sulfide linkages near the terminal portions of the polymer are also prepared by thermal polymerization, typically at about 80° to 90° C., of at least one alkyl acrylate in the presence of at least one hydroxyl-containing disulfide described heretofore, and an initiator such as azoisobutyronitrile. Solvents, suspending agents, sensitizers, etc. may be used as described heretofore.

Air or oxygen has an inhibiting effect on the reactions for preparing statistical dihydroxyl terminated liquid polymers and preferably is excluded from the reaction vessel. Therefore, the reaction vessel desirably is flushed with nitrogen before the vessel is charged and a nitrogen purge may be continued if necessary to exclude air during polymerization. The reaction generally is conducted with stirring at about 80° to 90° C., with cooling provided if necessary. The polymerization rate may be monitored by withdrawing reaction mixture samples at periodic intervals for percent conversion analysis. The reaction can be run to 100 percent conversion, but it generally is more economical to run to about 70 to 98 percent conversion and recover unreacted monomer for reuse. The hydroxyl-containing liquid polymer may be purified by vacuum distillation or by washing with water in order to remove the unreacted hydroxyl-containing disulfide, followed by drying the polymer. The structure of the hydroxyl-containing liquid polymer can be confirmed by infrared analysis, together with well known wet chemical methods for determination of hydroxyl and sulfur content. Number average molecular weights (Mn) can be measured using vapor pressure osmometry, gel permeation chromatography, or the like.

Another suitable difunctional hydroxyl-terminated polymer is an epihalohydrin type polymer having a number average molecular weight of about 3300, which is described in U.S. Pat. No. 3,850,856 and is hereby fully incorporated by reference.

Still another suitable elastomer which can be utilized for adduction into the unsaturated polyester resin in the present invention, is the diepoxy-terminated type polymers, which is fully described in U.S. Pat. No. 4,530,962, which is hereby fully incorporated by reference.

The low viscosity statistical monofunctional reactive liquid polymer compositions useful in the present invention for reaction into the backbone of the precursor unsaturated polyester resin, generally consist of two different types produced by two distinct processes. More particularly, the first type is a reaction product statistical monofunctional polymer composition, and the second type is a blended product statistical monofunctional polymer composition. It is to be understood that the term “statistical monofunctional” used for describing the reactive liquid polymers useful in the present invention, means that the rubber or elastomer is regarded, statistically, as having 100 percent monofunctional end groups. However, the statistical monofunctional rubber composition may include difunctional, non-functional, and monofunctional species, or alternatively only difunctional and nonfunctional species, as will be described in greater detail below.

The greatest advantage provided by these statistical monofunctional polymers is that their viscosity is approximately one-half (½) the value of equivalent commercially known difunctional polymers.

Reaction Products of Reactive Liquid Polymers and Epoxy Resins

As described above the curable compositions contain a adduct of one or more of the above epoxy resins with one or more of the above reactive liquid polymers. The adducts may be admixtures of the polymer or may be actual reaction products. These adducts are present in amount from about 5 to about 25, or from about 8 to about 22, or from about 10 to about 20 parts by weight.

The adduct may be prepared from any of the above reactive liquid polymers and the epoxy resins. Generally, from about 25 to about 75, or from about 30 to about 68, or from about 40 to about 60 parts of reactive liquid polymer is used with from about 75 to about 25, from about 70 to about 32, or from about 60 to about 40 parts of the epoxy resin. A particularly useful adduct is prepared from a carboxyl terminated polymer and a diglycidyl ether. A specific example of the adduct is the adduct of carboxyl-terminated butadiene acrylonitrile compounds reacted with a diglycidyl ether of bisphenol A at a ratio of 40:60. Compounds of this type are commercially available from Shell Chemical Co. under the Epon™ resin trade designation, such as, for example, Epon™ resin 58005, Epon™ resin 58006, Epon™ resin 58032, and Epon™ resin 58042.

Reactive Diluent

In one embodiment, the curable composition contains a reactive diluent. This may be any material which contributes to the cross linking of the compositions. These diluents are present in an amount from about 0 to about 16, or from about 2 to about 14, or from about 5 to about 12 parts by weight. In one embodiment, the reactive diluents are glycidyl ethers. Commercial examples of these materials include Heloxy 7 (laiphatic monoglycidyl ether of C8-10 alkyl chains), Heloxy 48 (trimethylolpropane triglycidyl ether), Heloxy 61 (butyl glycidyl ether), Heloxy 62 (cresyl glycidyl ether) and Heloxy 505 (polyglycidyl ether of castor oil). These products are available form Resolution Performance Products.

Curing Agents

The present curable composition may be cured by any known curing agent. The curing agents are known to those in the art and include amines, acids, alcohols and the like. In one embodiment, the curable compositions are cured with an anhydride curing agent. Typically the curing agent is delivered and added to the curable composition. The curing agent is mixed with the Part A of the curable composition. The curing agent is typically referred to as Part B. The curing agent makes up a major portion of the Part B. Typically, the curing agent is used at an equal weight ratio to the curable composition. In one embodiment, the curing agent is added to the curable composition at a ratio of about 0.5 to 1.5 parts of curable composition to about 1.5 to about 0.5 part of the curing agent.

The acid anhydrides used as the curing agent in the process of the invention may be any anhydride derived from a carboxylic acid which possesses at least one anhydride group. The carboxylic acids used in the formation of the anhydrides may be saturated, unsaturated, aliphatic, cycloaliphatic, armatic or heterocyclic. Examples of these anhydrides include, among others, phthalic anhydride, isophthalic anhydride, di-, tetra- and hexahydrophthalic anhydride, 1, 3, 5, 6, 7, 7-hexachloro-3.6-endomethylene 1,2,3,6 tetrahydrophthalic anhydride (chlorendic anhydride), succinic anhydride, maleic anhydride, chlorosuccinic anhydride, monochloromaleic anhydride, 6-ethyl-, 4-cyclohexadiene, 1,2-dicarboxylic acid anhydride, 3,6-dimethyl-4-cyclohexadiene-1,2-dicarboxylic acid anhydride, 6-butyl-3,5-cyclohexadiene-1,2-dicarboxylic acid anhydride, octadecylsuccinic acid anhydride, dodecylsuccnic acid anhydride, dioctyl succinic anhydride, nonadecadienylsuccinic anhydride, 3-methoxy-1,2,3,6-tetrahydrophthalic acid anhydride, 3-butoxy-1,2,3,6-tetrahydrophthalic anhydride, pyromellitic anhydride, di-, tetra- and hexahydropyromellitic anhydride, polyadipic acid anhydride, polysebacic acid anhydride, and the like and mixtures thereof.

Useful anhydrides to be employed in the process comprises the aromatic mono- and dianhydrides, aliphatic and cycloaliphatic monoanhydrides, and the chlorinated derivatives of the aforedescribed mono- and dianhydrides.

Other suitable agents include the trimellitic anhydride adducts such as the trimellitic anhydride-polyhydric alcohol adducts, including an adduct of a glycol such as ethylene glycol. Still other suitable agents include the benzophenone tetracarboxylic diahydrides, such as 3,3′,4,4′-benzophenone tetracarboxylic dianhydride; 2-bromo-3,3′,4,4′-benzophenone tetracarboxylic dianhydride; and 5-nitro-3,3′,4,4′-benzophenone tetracarboxylic dianhydride. Other well known anhydrides that are utilizeable here are the polyfunctional cyclic anhydrides. Among these, mention may be made of pyromellitic tetracarboxylic acid dianhydride, cyclopentane tetracarboxylic acid dianhydride, diphenylether tetracarboxylic acid dianhydride, and the hexacarboxylic acid trianhydrides of benzene, and of cyclohexane. Other useful anhydrides include the linear of cyclic anhydrides of any of the following acids: oxalic acid, malonic acid, glutaric acid, adipic acid, pimelic acid, azelaic acid, sebacic acid, brassylic acid, trimellitic acid, dimer fatty acid, trimer fatty acid and the polyester acid, such as the diacid from an excess of azelaic acid and neopentyl glycol sold under the tradename “Emery Diacid”, by Emery Chemical Company and having an equivalent weight of 500.

Commercially available anhydride curing agent include [methyl tetrahydrophthalic anhydride (MTHPA) (Lindride 6), Nadic methyl anhydride (NMA) (Aldrich), Epiclon B-4400 (an adduct of piperylene with two moles of maleic anhydride, sold by Dainippon Ink), and benzophenonetetracarboxylic dianhydride (BTDA) (Aldrich).

The curing agent may be used together with an accelerator. The accelaters are generally present in an amount from about 0.25 to about 5, or from about 0.5 to about 2.5, or from about 1 to about 2 parts by weight of Part B. Examples of the curing accelerators include, for example, organotin compounds, acidic phosphate ester compounds, the products of reaction between acidic phosphate ester compounds and amines, saturated or unsaturated polyvalent carboxylic acids or acid anhydrides thereof, and organic titanate compounds. Illustrative organotin compounds include dibutyltin dilaurate, dioctyltin dimaleate, dibutyltin phthalate, tin octylate and dibutyltin methoxide. Illustrative organic titanates are titanate esters such as tetrabutyl titanate, tetraisopropyl titanate and triethanolamine titanate.

The curable compositions may be prepared by means known to those of skill in the art. Generally, the components of the curable composition (Part A) are combined by blending at ambient or slightly elevated temperatures. When used, the curable composition is combined with the curing agent and accelerator (Part B). The curing mixture is then resin infused into a permeable material where it cures to form laminate. In one embodiment, a few plies of permeable material are laid up to a thickness from about 0.1 to about 1, or from about 0.2 to about 0.5, or about 0.25 inches. The permeable material is infused with resin at a temperature from about 80 to about 160, or from about 100 to about 140, or about 1200 C. The infused material is then heated to a temperature from about 150 to about 200, or from about 160 to about 190, or from about 170 to about 180° C. The infused materials are maintained at this temperature for about 1 to about 7, or from about 2 to about 6, or from about 3 to about 5, or about 4 hours.

The following are examples of the curable compositions. These compositions are added to Part B (102 parts of Lindride 6 curing agent and 1.5 parts of accelerator). The amounts in the following table are by weight.

| | 1 | 2 | 3 | 4 | 5 |
|---|---|---|---|---|---|
| EPON 862 | 55 | 75 | 80 | 82 | 85 |
| EPON 58006 | 20 | 16 | 15 | 14.3 | 12 |
| ETBN¹ | 20 | 14 | 16 | 17.5 | 11 |
| HELOXY 61 | — | 6 | 8 | 10 | 12 |

¹epoxy terminated butadiene acrylonitrile liquid rubber

The curable composition may be used to prepare laminates as described herein. Following is a description of one means of making the laminates by resin infusion. Other resin infusion systems will work with the curable compositions. The following is not intended to be limiting.

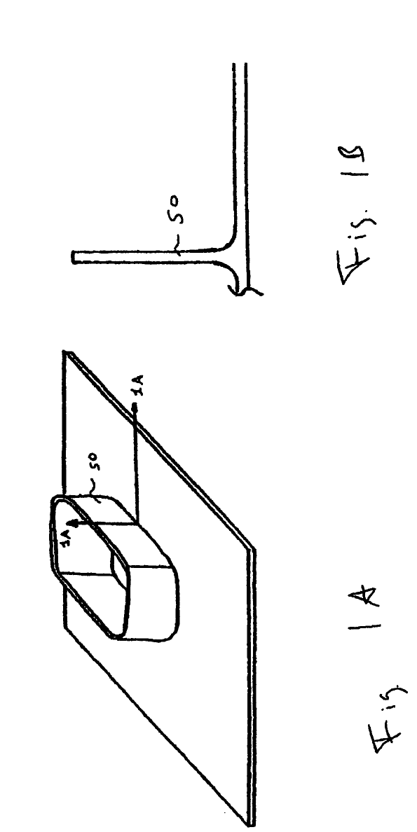

Referring now to the drawings wherein like reference numerals designate like or corresponding parts throughout different views, there is shown in FIGS. 1A and 1B, a mold (or tool or film layer, etc.) on which a permeable, fibrous reinforcing substrate is to be placed to form a finished part. The mold is preferably rigid for durability. The shape of the mold determines the shape of the finished part, and thus the mold can be curved or of any desired shape.

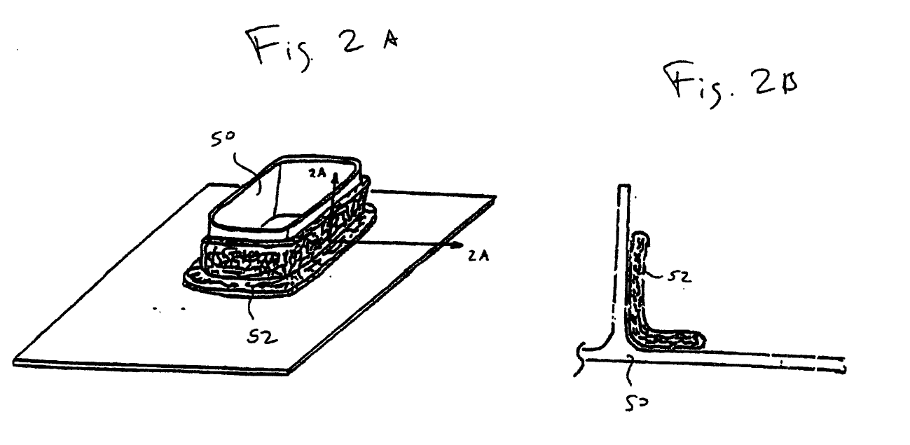

Referring now to FIGS. 2A and 2B, a permeable sheet 52 of reinforced or reinforcing fibrous material is placed on top of the mold 50. Sheet 52 is preferably a laminate or preform. The laminate 52 is laid up onto the mold 50 in the shape of the mold 50. The laminate 52 is preferably in the form of a preformed cloth. However, other types of reinforcing material structures known in the art, such as woven roving mat, continuous roving mat or chopped mat may be used instead of or in addition to the cloth. Furthermore, chopped fibers, continuous roving or certain aggregate fillers can also be used for this laminate if desired. The material for the reinforcing cloth or fibers may be any of a number of materials known in the art for RTM purposes, such as carbon, fiberglass, kevlar, nylon, graphite or the like.

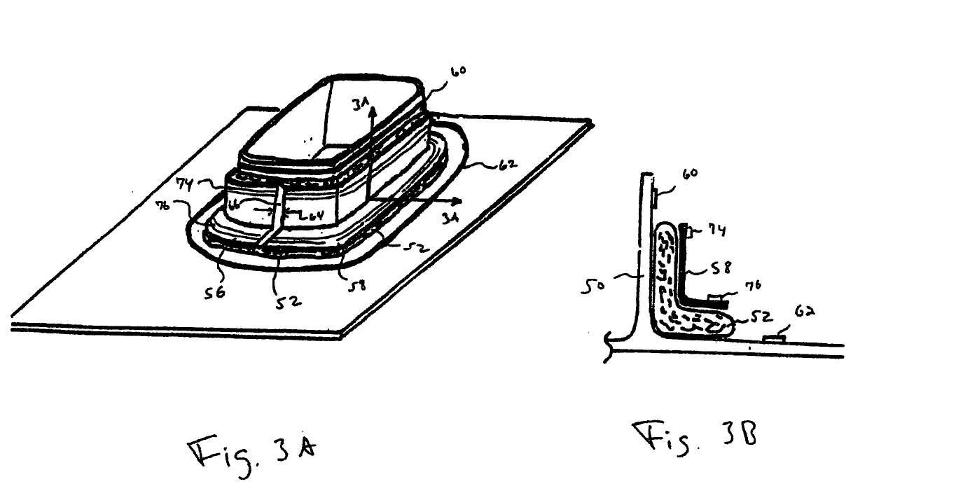

Referring now to FIGS. 3A, 3B and 3C, a pair of outer tool segments 56, 58 are thereafter placed on the outer surface of the reinforced material 52. Tools 56, 58 are formed generally in the shape of the mold 50 so as to press and form the laminate to the mold when placed under vacuum. Strips 60, 62 of tacky tape are adhered on the mold above and below the reinforced material 50, respectively for sealing the laminate from atmosphere. Strips 74, 76 of tacky tape are adhered at the top and bottom of the tool segments, respectively, also for sealing the laminate from the atmosphere.

A gap 64 is present between the tool segments 56, 58. A similar gap (not shown) is present on the other side of the mold. The gap provides for movement of the tool segments 56, 58 when they are placed under a vacuum. Movement of the tool segments facilitates an even force to be distributed on the reinforced material around the complex, three-dimensional shape of the mold.

A bridge, joint or coupler 66 bridges each gap 64 and is disposed between the tool segments and the laminate 52. The gaps 64 and couplers 66 perform the same function as the tool segments while allowing movement of the segments 58 to thereby facilitate even pressure distribution on the laminate while under vacuum.

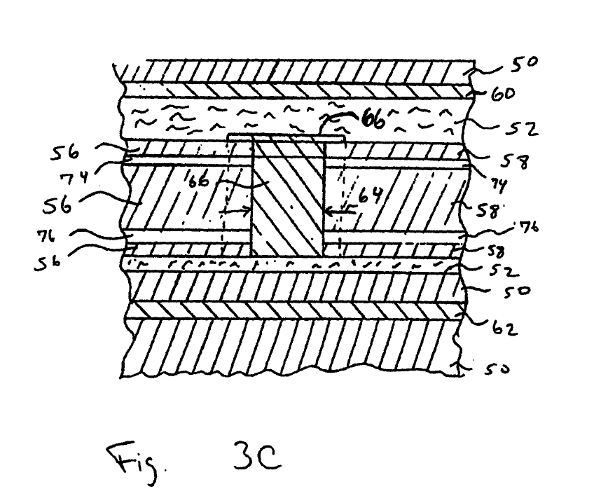

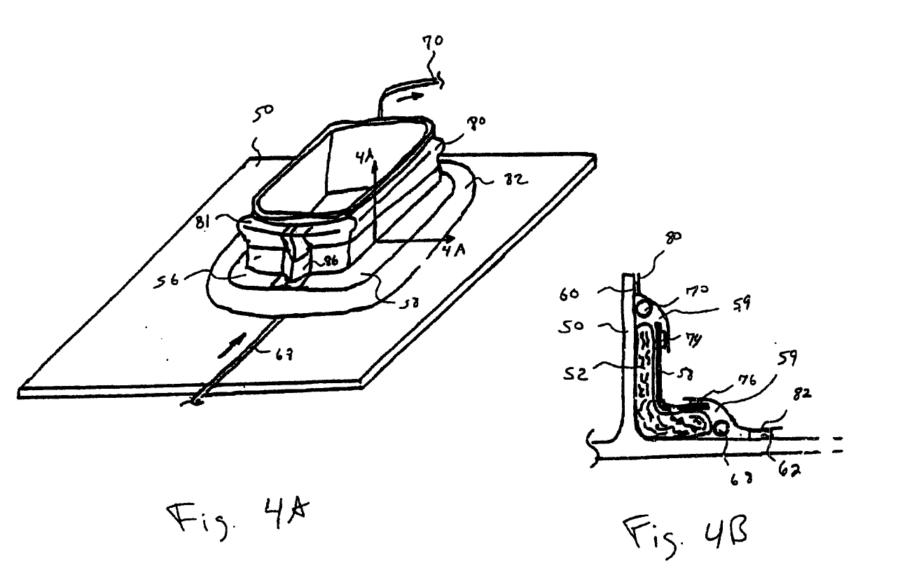

Referring now to FIGS. 4A and 4B, a resin feed line 68 and a vacuum/return line 70 are disposed in close proximity to the bottom and the top of the laminate 52, respectively. Movement of resin into the assembly will be in the direction of the arrows shown. Vacuum line 70 is preferably placed in a continuous loop around the entire mold. Feed line 68 need not necessarily be placed completely around the mold, but must be placed in such a manner so as to facilitate an even distribution of resin through the entire laminate. The required placement and amount of feed line is thus determined on a case by case basis depending on the particular structure being manufactured. A strip of tacky tape 74 is placed near the top edge of tool segments 56, 58. A strip of tacky tape 76 is placed near the bottom edge of tool segment 56, 58.

Sheets 80, 81 or strips of flexible, impermeable bag material are placed over the top of the reinforced material and adhered to the tacky tape strips (60, 74 for segment 58) so as to seal the top of the mold 50 to the tops of the tool segments 56, 58. A bottom impermeable sheet 82 is adhered to the tacky tape strips (62, 76 for segment 58) at the bottom of the tool segments 56, 58 so as to seal the bottom of the mold 50 to the bottom of the tool segments.

Referring now to FIG. 4C, bagging material sections 80, 81, 82 are sealed between the mold 50 and the semi-rigid tool segments 56, 58 utilizing the tacky tape. Additional strips of tacky tape 88, 89, 90 and 91 are adhered on top of the bagging material sections 80, 81, 82 and semi-rigid tool segments 56, 58 and mold 50. A section of bagging material 86 is thereafter adhered or sealed to the tape sections to thereby completely seal the gap 64 across the semi-rigid tool segments 56, 58. The preform is thereby completely sealed within a chamber or envelope 59.

The resin infusion process of the present invention is conducted as follows. After assembly of the mold, preform, semi-rigid tool, and bagging material, a vacuum is created via vacuum line 70. The vacuum removes air from the envelope and collapses the bagging material. The pressure differential across the envelope urges the semi-rigid tool segments toward each other by sliding across the couplers and against the surface of the laminate or preform. Resin is introduced via feed line 68 into the collapsed envelope 59 and will thereafter flow from the bottom of the mold 50 to the top of the mold and impregnate the preform 52 with the resin material.

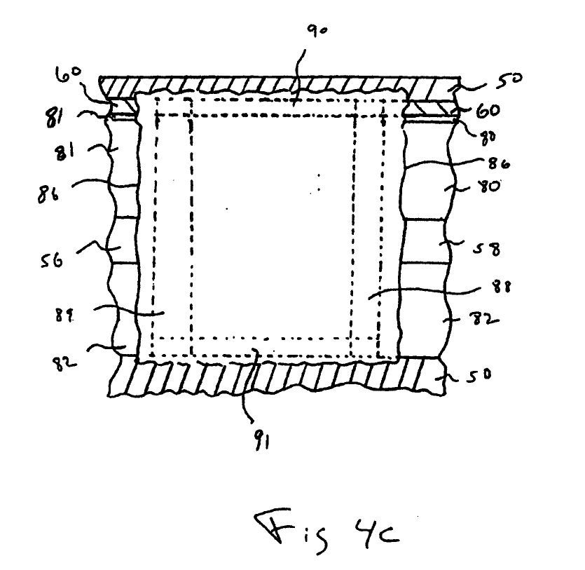

Referring now to FIG. 6, there is shown an isometric view of a section of a semi-rigid tool in accordance with the present invention. A pattern of lines, channels or indentations 110 are either formed or machined into the surface of the semi-rigid tool 108 which lies against the laminate. The pattern of interconnected channels 110 permits or facilitates the resin to flow in a more even distribution across the face of the preform 112.

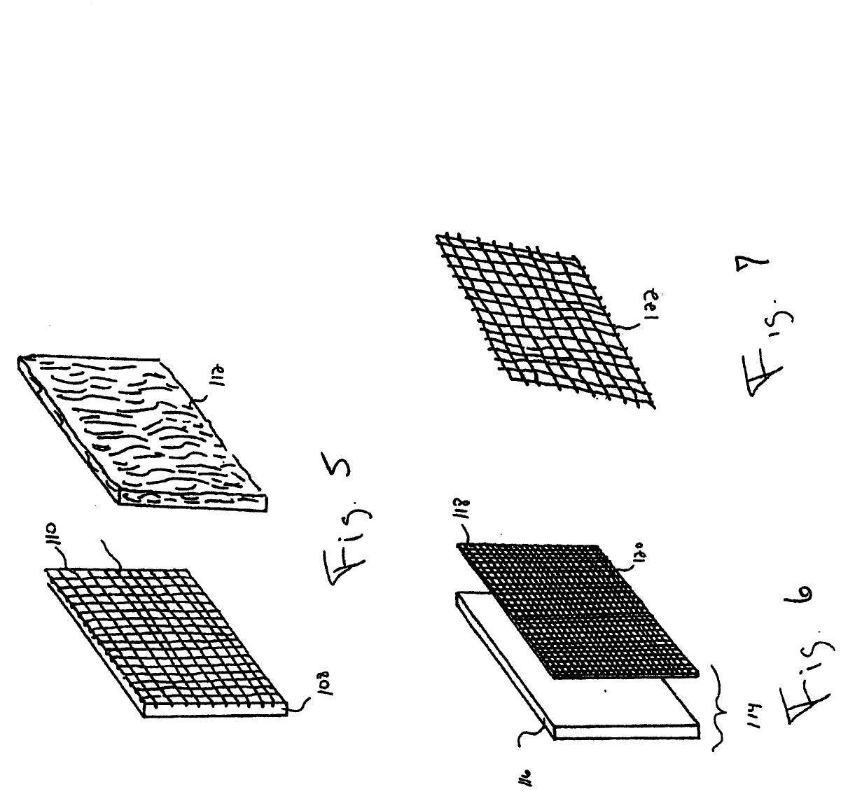

Referring now to FIG. 7, alternatively from the tool of FIG. 6, a tool 114 may be comprised of a solid piece of tool material 116 having a second sheet of tool material 118 having a pattern of channels 120 provided therein. The channeled piece 118 is suitably attached, bonded or adhered to the non-channel piece 116 to facilitate even resin flow as described hereinbefore.

Referring now to FIG. 8, alternatively from the tool of FIG. 6, a screen or mesh 122 could be used in place of a channeled piece 118 in FIG. 7. A screen or mesh would thereby be suitably attached, adhered or bonded to the smooth sheet or panel 116 shown in FIG. 7 to facilitate even resin flow as described hereinbefore.

The mold of the present invention is preferably made from a rigid, wear resistant material which is easily cleaned of all resin residue. Such mold materials are well known in the art and include metals, plastics, reinforced plastics, etc. The semi-rigid tool segments 56, 58 of the present invention can be made from any of a number of materials suitable for the purpose described herein that would be within the knowledge of those skilled in the art, such as the same material as the mold. They are preferably made from a non-elastomeric, non-film material having a modulus of elasticity lower than the material of the mold, however. The semi-rigid tool material is preferably more rigid than the flexible bag material but less rigid than the mold material. Acceptable materials include one or two-ply composites which may be comprised of the same materials as the preform or laminate being processed. The semi-rigid tool is preferably elastic or resilient enough to bend so as to facilitate breaking of cured resin off of the tool segments after curing of the preform is completed.

The couplers 66 are preferably made from the same material as the semi-rigid tool 58, but may be made of other suitable materials as well.

The bagging materials 80, 82 may be any of a number of suitable materials known to those skilled in the art, such as thermoplastic polyamide films, polyethylene terephthalate (PET), polyether keytone (PEEK), polyetherimide (PEI), polyether cell foam (PES), etc.

While the invention has been explained in relation to its preferred embodiments, it is to be understood that various modifications thereof will become apparent to those skilled in the art upon reading the specification. Therefore, it is to be understood that the invention disclosed herein is intended to cover such modifications as fall within the scope of the appended claims.

1. A curable composition comprising a) at least one epoxy resin, b) at least one reactive liquid polymer, and c) at least one reaction product of an epoxy resin and a reactive liquid polymer.

2. The composition of claim 1 wherein a) is a diglycidyl ether of a bisphenol compound.

3. The composition of claim 1 wherein a) is a diglycidyl ether of bisphenol F.

4. The composition of claim 1 wherein b) is a carboxyl-terminated, hydroxy-terminated, epoxy-terminated polymer, or mixtures of two or more thereof.

5. The composition of claim 1 wherein b) is a dicarboxyl-terminated polymer, a dihydroxy-terminated polymer, a diepoxy-terminated polymer, a reaction product statistical monofunctional carboxyl-terminated polymer, a reaction product statistical monofunctional hydroxy-terminated polymer, a reaction product statistical monofunctional epoxy-terminated polymer, a blended product statistical monofunctional carboxyl-terminated polymer, a blended product statistical monofunctional hydroxy-terminated polymer, a blended product statistical monofunctional epoxy-terminated polymer or mixtures of two or more thereof.

6. The composition of claim 5 wherein b) has a polymer backbone derived from polyethylene, polyisobutylene, polybutadiene, polyisoprene, poly(ethylacrylate), copolymers of butadiene and acrylonitrile, copolymers of butadiene and acrylates, or copolymers of butadiene and styrene.

7. The composition of claim 1 wherein b) is a diepoxy-terminated polymer, a reaction product statistical monofunctional epoxy-terminated polymer, a blended product statistical monofunctional epoxy-terminated polymer or mixtures of two or more thereof.

8. The composition of claim 1 wherein b) has a Brookfield viscosities of from about 500 cps to about 2,500,000 cps at 25° C.

9. The composition of claim 1 wherein c) is a reaction product of 1) a dicarboxyl-terminated polymer, a dihydroxy-terminated polymer, a diepoxy-terminated polymer, a reaction product statistical monofunctional carboxyl-terminated polymer, a reaction product statistical monofunctional hydroxy-terminated polymer, a reaction product statistical monofunctional epoxy-terminated polymer, a blended product statistical monofunctional carboxyl-terminated polymer, a blended product statistical monofunctional hydroxy-terminated polymer, a blended product statistical monofunctional epoxy-terminated polymer or mixtures of two or more thereof and 2) at least one epoxy resin.

10. The composition of claim 8 wherein the epoxy resin is a diglycidyl ether of a bisphenol compound.

11. The composition of claim 1 wherein c) is a reaction product of 1) at least one epoxy resin and 2) a dicarboxyl-terminated polymer, a reaction product statistical monofunctional carboxyl-terminated polymer, a blended product statistical monofunctional carboxyl-terminated polymer, or mixtures of two or more thereof.

12. The composition of claim 10 wherein the epoxy resin is a diglycidyl ether of a bisphenol compound.

13. The composition of claim 1 further comprising d) at least one reactive diluent.

14. The composition of claim 12 wherein the reactive diluent is a glycidyl ether.

15. The composition of claim 1 further comprising a curing agent.

16. A composition comprising a) at least one diglycidyl ether of a bisphenol compound, b) at least one reactive epoxy liquid polymer, and c) at least one reaction product of 1) at least one epoxy resin and 2) a dicarboxyl-terminated polymer, a reaction product statistical monofunctional carboxyl-terminated polymer, a blended product statistical monofunctional carboxyl-terminated polymer, or mixtures of two or more thereof.

17. The composition of claim 15 wherein the bisphenol compound is bisphenol F.

18. The composition of claim 15 wherein b) is a carboxyl terminated polymer.

19. The composition of claim 1 further comprising d) at least one reactive diluent.

20. The composition of claim 12 wherein the reactive diluent is a glycidyl ether.

21. The composition of claim 1 further comprising a curing agent.

22. A method of manufacturing a resin impregnated reinforced article comprising the steps of: depositing a permeable reinforcing material on a rigid mold; sealing the material from the atmosphere; placing the material under vacuum; and, impregnating the material with the composition of claim 1.

23. The method of manufacturing a resin impregnated reinforced article of claim 22, wherein the permeable reinforcing material is comprised of a laminate.

24. The method of manufacturing a resin impregnated reinforced article of claim 22, wherein the permeable reinforcing material is comprised of preformed cloth.

25. A method of manufacturing a resin impregnated reinforced article comprising the steps of: depositing a permeable reinforcing material on a rigid mold; sealing the material from the atmosphere; placing the material under vacuum; and, impregnating the material with the composition of claim 16.

26. The method of manufacturing a resin impregnated reinforced article of claim 25, wherein the permeable reinforcing material is comprised of a laminate.

27. The method of manufacturing a resin impregnated reinforced article of claim 25, wherein the permeable reinforcing material is comprised of preformed cloth.

28. A laminate derived from a permeable reinforcing material and the composition of claim 1.

29. A laminate derived from a permeable reinforcing material and the composition of claim 16.
